(19) United States
(12) Patent Application Publication
(10) Pub. No.: US 2025/0290433 A1
(43) Pub. Date: Sep. 18, 2025

(54) SHROUD OF GAS TURBINE ENGINE AND METHOD OF MANUFACTURING THEREOF

(71) Applicant: ROLLS-ROYCE plc, London (GB)

(72) Inventors: Colin A. BELL, Derby (GB); Kadir PASLIOGLU, Deby (GB)

(73) Assignee: ROLLS-ROYCE plc, London (GB)

(21) Appl. No.: 19/052,487

(22) Filed: Feb. 13, 2025

(30) Foreign Application Priority Data
Mar. 13, 2024 (GB) 2403596.6

(51) Int. Cl. F01D 25/24

(52) U.S. Cl. CPC F01D 25/243; F05D 2230/54; F05D 2240/14; F05D 2250/13; F05D 2250/182; F05D 2250/184

(57) ABSTRACT

A shroud for a gas turbine engine, the shroud including: an arcuate base extending circumferentially about a central axis; a pair of opposing flanges extending from respective axial ends of the arcuate base; and a pair of tangs spaced apart from the arcuate base and extending towards each other. Moreover, the arcuate base, the pair of flanges, and the pair of tangs define a slot. Each tang defines a width extending from the respective flange and a thickness 10 orthogonal to the width. Each tang includes an undulating pattern extending along a whole of the thickness and at least a portion of the width. The undulating pattern of each tang is configured to at least partially engage with the complementary mating features of the plurality of stator vanes. Further, a method of manufacturing the shroud by using a metal sheet is disclosed.

### CROSS-REFERENCE TO RELATED APPLICATIONS

This specification is based upon and claims the benefit of priority from United Kingdom patent application GB 2403596.6 filed on Mar. 13, 2024, the entire contents of which is incorporated herein by reference.

### BACKGROUND

### Field of the Disclosure

The present disclosure relates to a shroud of a gas turbine engine and a method of manufacturing thereof.

### Description of the Related Art

In gas turbine engines, in particular in aircraft gas turbine engines, it is known to hold guide vanes or stator vanes at their radially inward-pointing end by means of a shroud. The shroud carries, on its radially inner side, an inlet layer for sealing over a drum or a disk (e.g., a compressor disk), which rotates about an engine axis or a central axis of the gas turbine engine. The shroud wears during operation of the gas turbine engine and needs to be replaced time to time. Further, conventional design of the shroud is such that the stator vanes may not be firmly supported by the shroud, thereby resulting in vibrations in the gas turbine engine.

Due to high temperatures and critical nature of the shroud, conventional manufacturing technique involves individually forging and machining of the shroud. Moreover, such forgings are usually of very expensive high temperature alloys. Such conventional method of manufacturing the shroud may be labour intensive and may involve higher cost of materials. In most of the applications, each shroud is in the form of a shroud ring including a plurality of shroud segments which are conventionally produced by machining a significant portion of the material from the forged shroud ring. During machining operation, a major portion of the material is removed from the forged shroud ring and converted to scrap metal chips.

The conventional method of manufacturing the shroud may require use of complex machine tools and rough machining process. Further, conventional manufacturing techniques could not provide a consistent material thickness throughout the cross-section of the shroud. Therefore, there is a need for an improved design of the shroud and an improved method of manufacturing the shroud which may overcome the above-mentioned limitations.

### SUMMARY

According to a first aspect, a shroud for a gas turbine engine is disclosed. The shroud includes an arcuate base extending circumferentially about a central axis. The shroud further includes a pair of opposing flanges extending from respective axial ends of the arcuate base. Each flange from the pair of flanges is inclined to the arcuate base. The shroud further includes a pair of tangs spaced apart from the arcuate base and extending towards each other. Each tang from the pair of tangs extends from a respective flange from the pair of flanges distal to the arcuate base. Each tang is inclined to the respective flange. Each tang defines a width extending from the respective flange and a thickness orthogonal to the width. The arcuate base, the pair of flanges, and the pair of tangs define a slot therebetween configured to at least partially receive therein complementary mating features of a plurality of stator vanes of the gas turbine engine. Each tang includes an undulating pattern extending along a whole of the thickness and at least a portion of the width. The undulating pattern includes alternating peaks and valleys, such that the peaks are distal to the arcuate base and the valleys are proximal to the arcuate base. The undulating pattern of each tang is configured to at least partially engage with the complementary mating features of the plurality of stator vanes.

As the undulating pattern of each tang is configured to at least partially engage with the complementary mating features of the plurality of stator vanes, the shroud of the present disclosure may firmly support the plurality of stator vanes. The undulating pattern of each tang engages with the complementary mating features of the plurality of stator vanes to provide an interference fit in such a way that there are minimal vibrations in the plurality of stator vanes during operation of the gas turbine engine. Such vibrations could otherwise lead to damage to the gas turbine engine. Additionally, this has an advantageous effect on a stability and an efficiency of the gas turbine engine.

The interference fit provided by the mating of the undulating pattern and the plurality of stator vanes may also provide an improved sealing by the shroud of the present disclosure to prevent compressed air from recirculating from areas with higher pressure into areas with lower pressure. In other words, the shroud of the present disclosure may provide an improved seal between rotor stages and against a secondary air system.

In some embodiments, the undulating pattern is a sinusoidal pattern. The sinusoidal undulating pattern may further improve sealing properties of the shroud of the present disclosure and also provide firm support to the plurality of stator vanes.

In some embodiments, the undulating pattern is a square wave pattern. The square wave undulating pattern may further improve sealing properties of the shroud of the present disclosure and also provide firm support to the plurality of stator vanes. Moreover, the square wave undulating pattern may also provide a better resistance to axial loading because the tang would be oriented in such a way as to be perpendicular to axial loading.

In some embodiments, the undulating pattern includes a plurality of trapezoidal projections forming the respective peaks. Each trapezoidal projection from the plurality of trapezoidal projections tapers inwardly in a direction from the respective peak towards the arcuate base. Such undulating pattern may provide a “spring effect” to the shroud that may help in returning the shroud to the original position after being subjected to any external forces.

In some embodiments, a height between each peak and the adjacent valley is greater than the thickness of the tang. This would accommodate any complementary mating feature in the slot that is greater than the thickness of the tang. This may further ensure a tight interference fit between the shroud and the plurality of stator vanes, thereby providing a firm support to the plurality of stator vanes and an improved sealing property of the shroud of the present disclosure. The height between each peak and the adjacent valley may be based on a geometry of the plurality of stator vanes.

In some embodiments, each tang has a circumferential length. The undulating pattern extends along a whole of the circumferential length. In this way, the plurality of stator vanes may be firmly supported by the shroud. Further, as the undulating pattern extends along the whole of the circumferential length, the sealing property of the shroud of the present disclosure also improves significantly.

In some embodiments, the shroud is formed from a single metal sheet. The single metal sheet is bent to form the arcuate base, the pair of flanges, and the pair of tangs. Use of the single metal sheet may lead to a substantially uniform thickness of the shroud thereby optimizing the durability and functionality of the shroud.

In some embodiments, each flange is orthogonal to the arcuate base. This provides a desirable geometry to the shroud such that the slot at least partially receives therein the complementary mating features of the plurality of stator vanes.

In some embodiments, each tang is orthogonal to the flange and parallel to the arcuate base. This provides the desirable geometry to the shroud such that the slot at least partially receives therein the complementary mating features of the plurality of stator vanes. Further, as each tang is orthogonal to the flange, a desirable interference fit may be achieved between each tang and the plurality of stator vanes.

According to a second aspect there is provided a shroud ring for a gas turbine engine of the first aspect. The shroud ring includes a plurality of shrouds contiguously connected to each other, such that the shroud ring extends circumferentially by 360 degrees about the central axis and forms a circumferential slot formed by the slots of the plurality of shrouds. In order to be able to assemble the shroud ring, the plurality of shrouds is connected as segments of the shroud ring. The circumferential slot formed by the slots of the plurality of shrouds is adapted to receive corresponding roots of the plurality of stator vanes, such that the shroud ring may provide firm support to the plurality of stator vanes with minimal vibrations during operation of the gas turbine engine. Further, the shroud ring may provide an improved sealing to prevent compressed air from recirculating from areas with higher pressure into areas with lower pressure in the gas turbine engine. In an application, the shroud ring may include four shrouds in total. In another application, the shroud ring may include eight shrouds in total.

According to a third aspect there is provided a gas turbine engine including the shroud ring of the second aspect. The inclusion of the shroud ring of the second aspect in the gas turbine engine may improve the stability of the gas turbine engine and increase a thermal efficiency of the gas turbine engine.

In some embodiments, the gas turbine engine further includes a plurality of stator vanes coupled to the shroud ring. Each stator vane includes a complementary mating feature that is at least partially received within the circumferential slot of the shroud ring. The mating feature and the circumferential slot of the shroud ring may ensure each stator vane from the plurality of stator vanes is being firmly held and supported by the shroud ring. As a result, during operation of the gas turbine engine, there are minimal vibrations in the plurality of stator vanes that could otherwise lead to damage to the gas turbine engine.

According to a fourth aspect there is provided a method of manufacturing the shroud of the first aspect. The method includes providing a metal sheet. The method further includes forming, by a plurality of rollers, the metal sheet to provide the arcuate base, the pair of flanges, and a pair of initial tangs extending from the pair of flanges. The method further includes forming the pair of initial tangs to provide the pair of tangs including the undulating pattern.

The proposed method involves the use of metal sheet to manufacture the shroud of the gas turbine engine. The metal sheet may be bent to form the shroud, specifically, the arcuate base, the pair of flanges, and the pair of initial tangs extending from the pair of flanges. Since the proposed method of manufacturing the shroud includes using sheet metal and forming steps rather than conventional techniques involving forging and machining, a very small volume of high-quality material would be required to manufacture the shroud. Hence, unlike the conventional techniques of shroud manufacturing such as forging and machining, the method of the present disclosure may significantly reduce the scrap metal in the manufacturing process, and thereby, providing efficient material utilization and cost-effective manufacturability of the shroud. Forming of metal sheet may not be labour intensive and may not involve higher cost of materials.

The manufacturing of the shroud is preferably carried out using the roll forming process. This may ensure easy manufacturing of shrouds that could otherwise require a considerable height in conventional techniques to produce forged and machined components. Moreover, cold rolling of the metal sheet may be used to increase or regulate the strength of the metal sheet and thereby, controlling the material quality of the shroud. Additionally, an improved finished surface could be provided to the shroud that does not require machining. Therefore, the method of the present disclosure may not involve complex machine tools and rough machining process for manufacturing the shroud. Moreover, the disclosed method of manufacturing the shroud may relatively use less energy, and therefore, may be more sustainable as compared to the conventional methods such as forging and machining.

Further, the method of the present disclosure manufactures the shroud such that the shroud may have a substantially uniform thickness which may optimize the durability and functionality of the shroud. The undulating pattern of the pair of tangs may ensure the tight interference fit between the shroud and the plurality of stator vanes, thereby providing the firm support to the plurality of stator vanes and the improved sealing property of the shroud of the present disclosure.

In some embodiments, forming the pair of initial tangs further includes incrementally forming the pair of initial tangs between a top tool and a bottom tool in a circumferential direction. The top tool and the bottom tool together may help in forming the undulating pattern of the tangs. For example, the top tool and the bottom tool may be, but not limited to, a die. The top tool and the bottom tool may be “indexed” to incrementally form the undulating pattern. This may ensure that forming the undulating pattern of the pair of tangs is cost effective and easy to implement.

In some embodiments, the pair of initial tangs is formed using one or more rollers from the plurality of rollers that form the metal sheet. Therefore, the one or more rollers may be used to form the metal sheet as well as form the pair of initial tangs so as to provide the pair of tangs including the undulating pattern. The one or more rollers may be provided with a customized pattern to produce the undulating pattern of the tangs.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed). The gearbox may be a reduction gearbox (in that the output to the fan is a lower rotational rate than the input from the core shaft). Any type of gearbox may be used.

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. The bypass duct may be substantially annular. The bypass duct may be radially outside the engine core. The radially outer surface of the bypass duct may be defined by a nacelle and/or a fan case.

Specific thrust of an engine may be defined as the net thrust of the engine divided by the total mass flow through the engine. At cruise conditions, the specific thrust of an engine described and/or claimed herein may be less than (or in the order of) any of the following: 110 Nkg-1s, 105 Nkg-1s, 100 Nkg-1s, 95 Nkg-1s, 90 Nkg-1s, 85 Nkg-1s or 80 Nkg-1s. The specific thrust may be in an inclusive range bounded by any two of the values in the previous sentence (i.e., the values may form upper or lower bounds), for example in the range of from 80 Nkg-1s to 100 Nkg-1s, or 85 Nkg-1s to 95 Nkg-1s. Such engines may be particularly efficient in comparison with conventional gas turbine engines.

A fan blade and/or aerofoil portion of a fan blade described and/or claimed herein may be manufactured from any suitable material or combination of materials. For example, at least a part of the fan blade and/or aerofoil may be manufactured at least in part from a composite, for example a metal matrix composite and/or an organic matrix composite, such as carbon fibre.

The fan of a gas turbine as described and/or claimed herein may have any desired number of fan blades, for example 14, 16, 18, 20, 22, 24 or 26 fan blades.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 is a sectional side view of a gas turbine engine, according to an embodiment of the present disclosure;

FIG. 2 is a sectional side view of a stator vane and a shroud ring of the gas turbine engine of FIG. 1, according to an embodiment of the present disclosure;

FIG. 3 is a sectional view of the shroud ring taken along a line A-A′ shown in FIG. 2, according to an embodiment of the present disclosure;

FIG. 4 is a sectional side view of a shroud of the shroud ring of FIG. 3, according to an embodiment of the present disclosure;

FIG. 5 is a sectional view of the shroud taken along a line B-B′ shown in FIG. 4, according to an embodiment of the present disclosure;

FIG. 6 is a sectional view of a shroud taken along the line B-B′ shown in FIG. 4, according to another embodiment of the present disclosure;

FIG. 7 is a sectional view of a shroud taken along the line B-B′ shown in FIG. 4, according to yet another embodiment of the present disclosure;

FIG. 8 is a flowchart for a method of manufacturing the shroud of FIG. 4, according to an embodiment of the present disclosure;

FIG. 9 is an arrangement for manufacturing an initial shroud that is further used by the method of FIG. 8 for manufacturing the shroud, according to an embodiment of the present disclosure;

FIG. 10 is a sectional side view of the initial shroud shown in FIG. 9, according to an embodiment of the present disclosure;

FIG. 11A is a sectional side view of the initial shroud of FIG. 10, the initial shroud being formed by a top tool and a bottom tool, according to an embodiment of the present disclosure; and

FIG. 11B is sectional view of the initial shroud taken along a line C-C′ shown in FIG. 11A, the initial shroud being formed by the top tool and the bottom tool, according to an embodiment of the present disclosure.

### DETAILED DESCRIPTION

Aspects and embodiments of the present disclosure will now be discussed with reference to the accompanying FIGS. Further aspects and embodiments will be apparent to those skilled in the art.

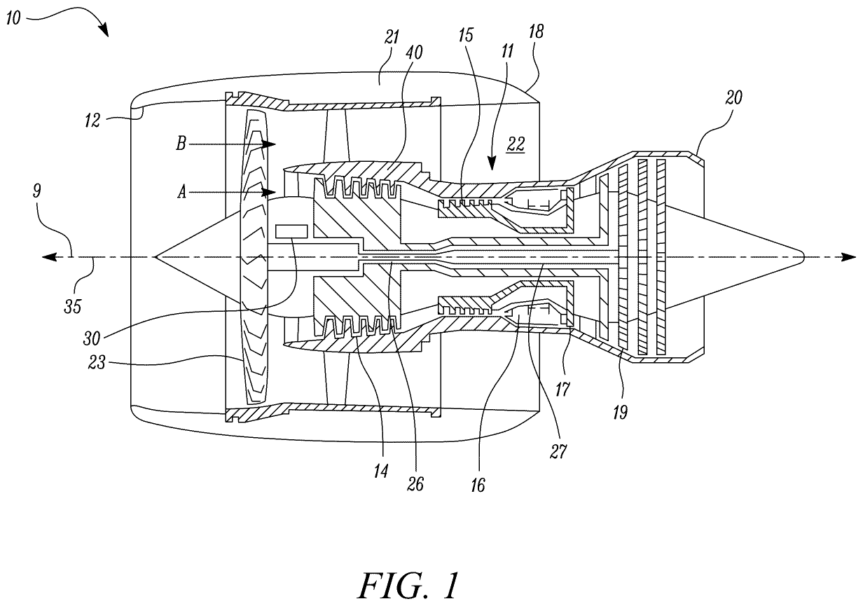

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises an engine core 11 that receives the core airflow A. The engine core 11 comprises, in axial flow series, a low pressure compressor 14, a high pressure compressor 15, a combustion equipment 16, a high pressure turbine 17, a low pressure turbine 19, and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the core exhaust nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

Note that the terms “low pressure turbine” and “low pressure compressor” as used herein may be taken to mean the lowest pressure turbine stages and lowest pressure compressor stages (i.e., not including the fan 23) respectively and/or the turbine and compressor stages that are connected together by the interconnecting shaft 26 with the lowest rotational speed in the engine 10 (i.e., not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 18, 20 meaning that the flow through the bypass duct 22 has its own nozzle 18 that is separate to and radially outside the core exhaust nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 may not comprise a gearbox 30.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial, and circumferential directions are mutually perpendicular.

The gas turbine engine 10 is an example of a turbomachine to which the invention can be applied. However, the present disclosure is equally applicable to other turbomachines, but not limited to, aero gas turbine engines, marine gas turbine engines, and land-based gas turbine engines.

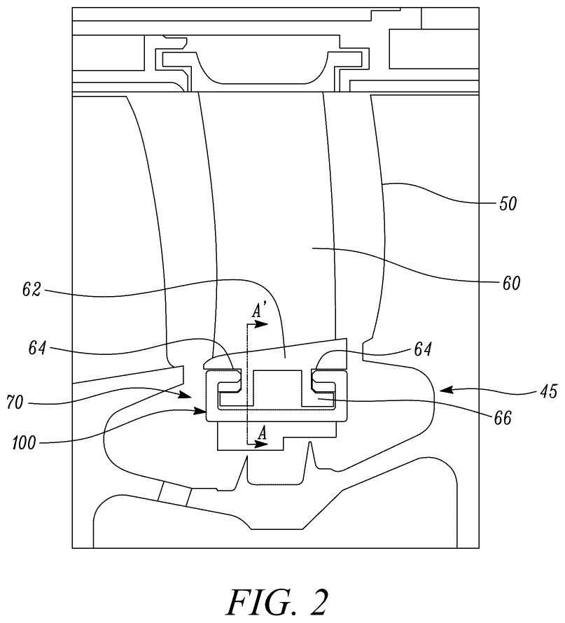

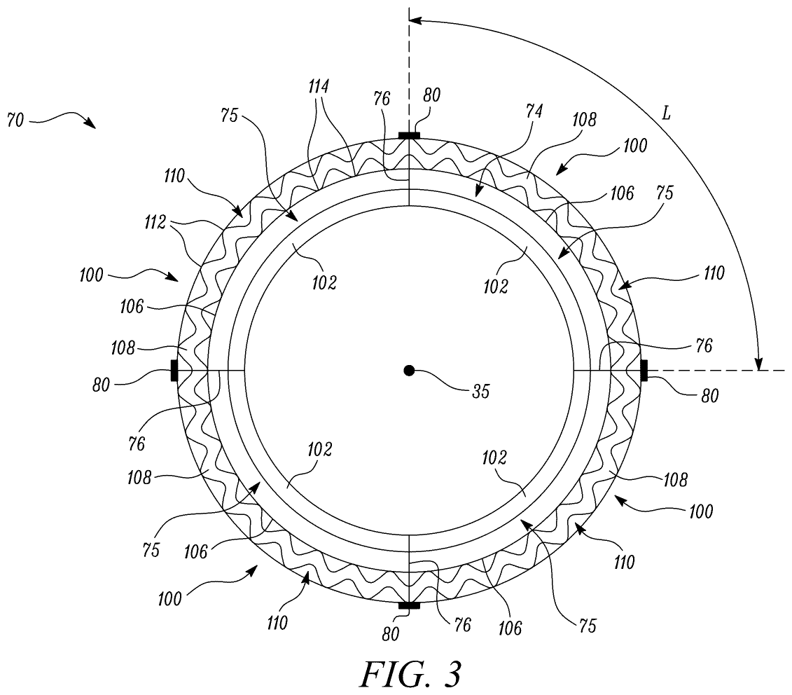

FIG. 2 is a sectional side view of a stator vane 60 and a shroud ring 70 of the gas turbine engine 10 shown in FIG. 1, according to an embodiment of the present disclosure. Referring to FIGS. 1 and 2, each of the low pressure compressor 14 and the high pressure compressor 15 includes at least one rotor stage having a plurality of rotor blades 50 and at least one stator stage having a plurality of stator vanes 60 (also known as stator blades). For illustrative purposes, only a single stator vane 60 and a single rotor blade 50 are shown in FIG. 2. The plurality of stator vanes 60 extends circumferentially around a central axis 35 (shown in FIGS. 1 and 3) and is disposed radially inward of an engine housing 40 (shown in FIG. 1). The central axis 35 is aligned with the principal rotational axis 9 of the gas turbine engine 10.

In the illustrated embodiment of FIG. 2, the stator vane 60 and the rotor blade 50 are associated with the high pressure compressor 15 and/or the low pressure compressor 14 (shown in FIG. 1). However, in other embodiments, the stator vane 60 and the rotor blade 50 may be associated with the high pressure turbine 17 and/or the low pressure turbine 19 (shown in FIG. 1). The plurality of stator vanes 60 and the plurality of rotor blades 50 protrude radially outwardly from a rotatable disk 45. In the illustrated embodiment of FIG. 2, the disk 45 is a compressor disk or a compressor drum. However, in embodiments where the plurality of stator vanes 60 and the plurality of rotor blades 50 are associated with the high pressure turbine 17 and/or the low pressure turbine 19 (shown in FIG. 1), the disk 45 is a turbine disk or a turbine drum.

The gas turbine engine 10 (shown in FIG. 1) includes the shroud ring 70 for supporting the plurality of stator vanes 60. The plurality of stator vanes 60 are coupled to the shroud ring 70. The shroud ring 70 receives the plurality of stator vanes 60. Each stator vane 60 from the plurality of stator vanes 60 has a radially inward root 62, which is provided with two grooves 64 and a complementary mating feature 66. The complementary mating feature 66 of each stator vane 60 is at least partially received within the shroud ring 70 in order to couple the stator vane 60 with the shroud ring 70.

FIG. 3 is a sectional view of the shroud ring 70 taken along a line A-A′ shown in FIG. 2, according to an embodiment of the present disclosure. In the illustrated embodiment of FIG. 3, the shroud ring 70 includes a plurality of shrouds 100 contiguously connected to each other, such that the shroud ring 70 extends circumferentially by 360 degrees about the central axis 35 and forms a circumferential slot 74 formed by slots 75 of the plurality of shrouds 100. The slots 75 of the plurality of shrouds 100 will be discussed later in the description.

The plurality of shrouds 100 is connected to each other as segments of the shroud ring 70. Further, in the illustrated embodiment of FIG. 3, the plurality of shrouds 100 includes four shrouds 100 in total which are contiguously connected to each other to form the shroud ring 70. However, in other embodiments, the plurality of shrouds 100 may include more than four shrouds 100 in total. In other embodiments, the shroud ring 70 may include only one shroud 100 that extends circumferentially by 360 degrees about the central axis 35.

The plurality of shrouds 100 may be connected to each other by using fasteners or welding. The shroud ring 70 may include a plurality of sealing strips 80 configured to span between the adjacent shrouds 100 from the plurality of shrouds 100 over gaps 76 between the adjacent shrouds 100. The complementary mating feature 66 of each stator vane 60 (shown in FIG. 2) is at least partially received within the corresponding slot 75 of the plurality of shrouds 100, thereby coupling the plurality of stator vanes 60 to the shroud ring 70. In other words, each stator vane 60 includes the complementary mating feature 66 that is at least partially received within the circumferential slot 74 of the shroud ring 70.

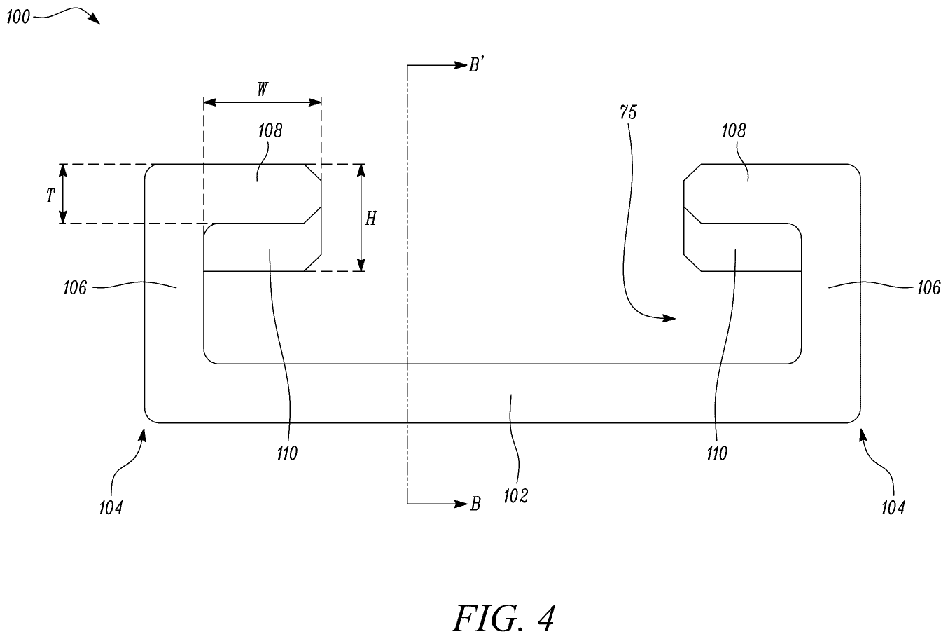

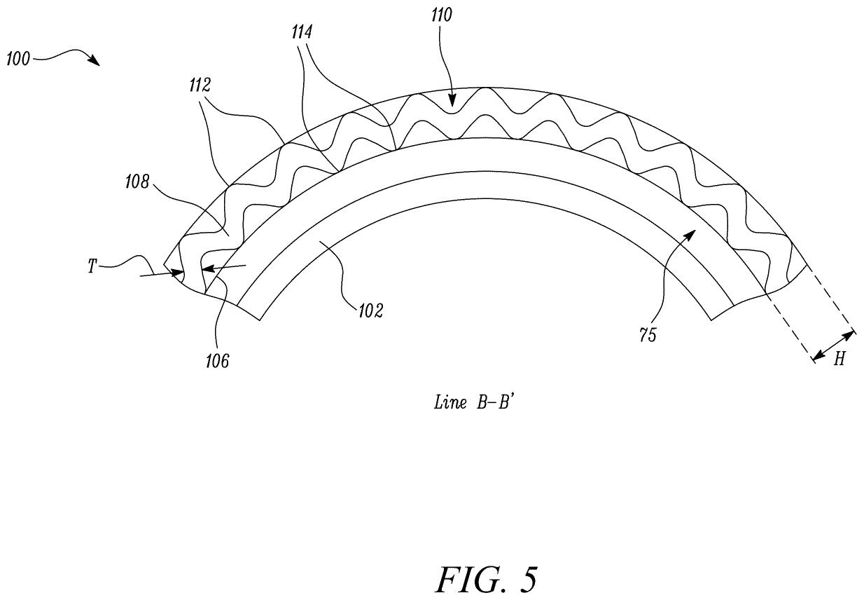

FIG. 4 is a sectional side view of the shroud 100 for the gas turbine engine 10 of FIG. 1, according to an embodiment of the present disclosure. FIG. 5 is a sectional view of the shroud 100 taken along a line B-B′ shown in FIG. 3, according to an embodiment of the present disclosure. Referring to FIGS. 1 to 5, the shroud 100 includes an arcuate base 102 extending circumferentially about the central axis 35 (shown in FIG. 3). The shroud 100 further includes a pair of opposing flanges 106 extending from respective axial ends 104 of the arcuate base 102. Each flange 106 from the pair of flanges 106 is inclined to the arcuate base 102. In some embodiments, each flange 106 is orthogonal to the arcuate base 102. This may provide a desirable geometry to the shroud 100 such that the slot 75 of the shroud 100 at least partially receives therein the complementary mating features 66 of the plurality of stator vanes 60 (shown in FIG. 2).

The shroud 100 further includes a pair of tangs 108 spaced apart from the arcuate base 102 and extending towards each other. Each tang 108 from the pair of tangs 108 extends from a respective flange 106 from the pair of flanges 106 distal to the arcuate base 102. Each tang 108 is inclined to the respective flange 106. In some embodiments, each tang 108 is orthogonal to the flange 106 and parallel to the arcuate base 102. This may provide the desirable geometry to the shroud 100 such that the slot 75 of the shroud 100 at least partially receives therein the complementary mating features 66 of the plurality of stator vanes 60. Each tang 108 defines a width W extending from the respective flange 106 and a thickness T orthogonal to the width W.

The arcuate base 102, the pair of flanges 106, and the pair of tangs 108 define the slot 75 (shown in FIGS. 4 and 5) therebetween configured to at least partially receive therein the complementary mating features 66 of the plurality of stator vanes 60 (shown in FIG. 2) of the gas turbine engine 10.

Further, each tang 108 includes an undulating pattern 110 extending along a whole of the thickness T and at least a portion of the width W. In some embodiments, the undulating pattern 110 may extend along a whole of the width W. In some embodiments, each tang 108 has a circumferential length L (shown in FIG. 3), and the undulating pattern 110 extends along a whole of the circumferential length L.

The undulating pattern 110 includes alternating peaks 112 and valleys 114, such that the peaks 112 are distal to the arcuate base 102 and the valleys 114 are proximal to the arcuate base 102. In the illustrated embodiment of FIG. 5, the undulating pattern 110 is a sinusoidal pattern. The undulating pattern 110 of each tang 108 is configured to at least partially engage with the complementary mating features 66 of the plurality of stator vanes 60. Due to engagement of the undulating pattern 110 of each tang 108 with the complementary mating features 66 of the plurality of stator vanes 60, the shroud 100 may provide firm support to the plurality of stator vanes 60.

The undulating pattern 110 of each tang 108 engages with the complementary mating features 66 of the plurality of stator vanes 60 to provide an interference fit in such a way that there are minimal vibrations in the plurality of stator vanes 60 during operation of the gas turbine engine 10. Such vibrations could otherwise lead to damage to the gas turbine engine 10. Additionally, this has an advantageous effect on stability and efficiency of the gas turbine engine 10.

The interference fit provided by the mating of the undulating pattern 110 and the plurality of stator vanes 60 may also provide an improved sealing by the shroud 100 to prevent compressed air from recirculating from areas with higher pressure into areas with lower pressure. In other words, the shroud 100 may provide an improved seal between rotor stages and against a secondary air system.

In some embodiments, a height H between each peak 112 and the adjacent valley 114 is greater than the thickness T of the tang 108. This would accommodate any complimentary mating feature 66 in the slot 75 that is greater than the thickness T of the tang 108. This may further ensure a tight interference fit between the shroud 100 and the plurality of stator vanes 60, thereby providing a firm support to the plurality of stator vanes 60 and an improved sealing property of the shroud 100. The height H between each peak 112 and the adjacent valley 114 may be based on a geometry of the plurality of stator vanes 60.

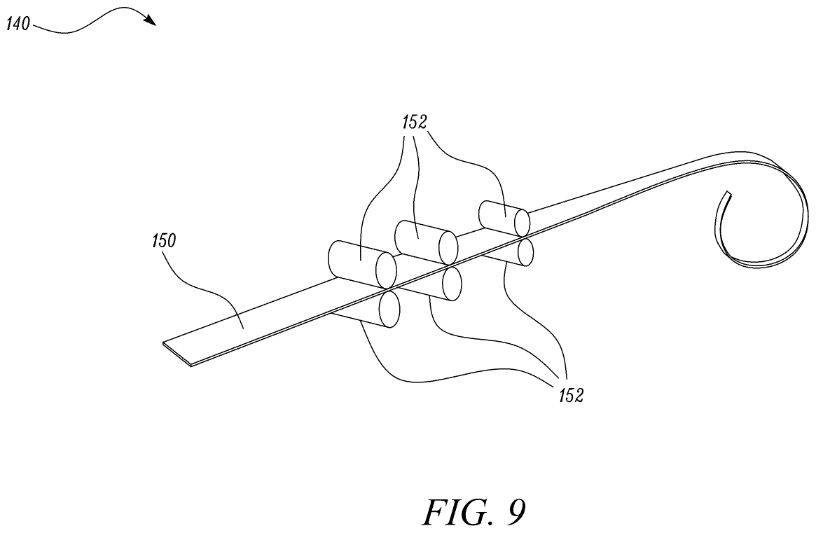

In some embodiments, the shroud 100 is formed from a single metal sheet (e.g., a metal sheet 150 shown in FIG. 9). The single metal sheet is bent to form the arcuate base 102, the pair of flanges 106, and the pair of tangs 108. Use of the single metal sheet may lead to a substantially uniform thickness of the shroud 100 thereby optimizing the durability and functionality of the shroud 100.

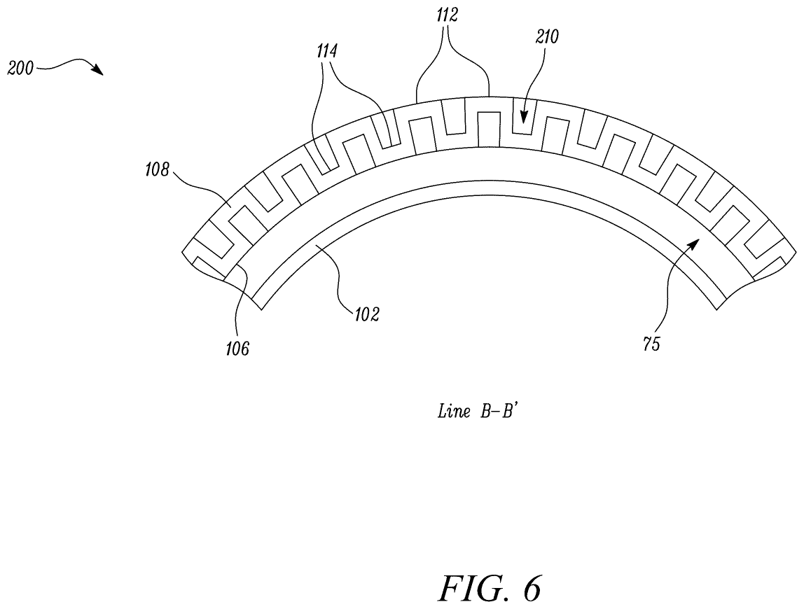

FIG. 6 is a sectional view of a shroud 200 taken along the line B-B′, according to another embodiment of the present disclosure. The shroud 200 is substantially similar to the shroud 100 of FIG. 5, with common components being referred to by the same numerals. However, in the shroud 200, each tang 108 includes an undulating pattern 210 (instead of the undulating pattern 110 shown in FIG. 5). The undulating pattern 210 has a different shape and geometry than the undulating pattern 110 shown in FIG. 5.

In the illustrated embodiment of FIG. 6, the undulating pattern 210 is a square wave pattern. The square wave undulating pattern 210 may further improve sealing properties of the shroud 200 and also provide support to the plurality of stator vanes 60 (shown in FIG. 2). Moreover, the square wave undulating pattern 210 may also provide a better resistance to axial loading because the tang 108 would be oriented in such a way as to be perpendicular to axial loading.

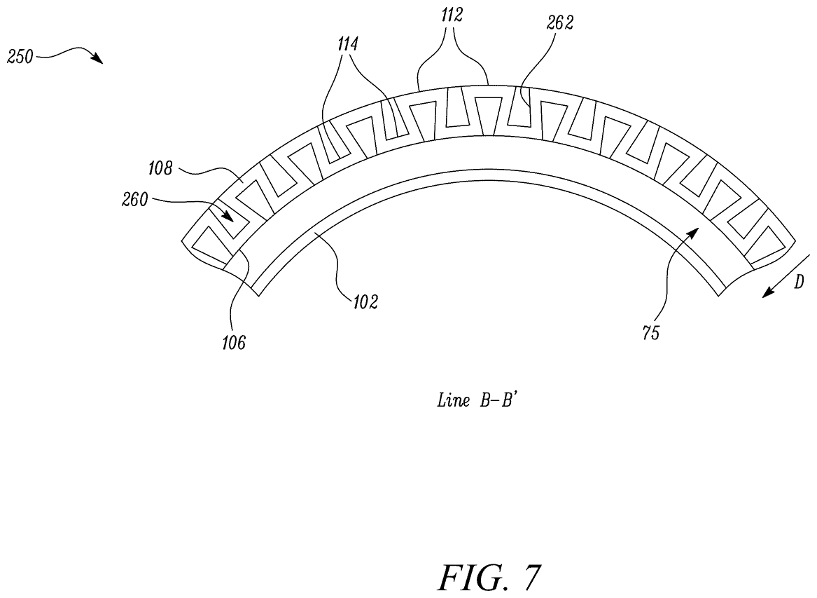

FIG. 7 is a sectional view of a shroud 250 taken along the line B-B′, according to another embodiment of the present disclosure. The shroud 250 is substantially similar to the shroud 100 of FIG. 5, with common components being referred to by the same numerals. However, in the shroud 250, each tang 108 includes an undulating pattern 260 (instead of the undulating pattern 110 shown in FIG. 5). The undulating pattern 260 has a different shape and geometry than the undulating pattern 110 shown in FIG. 5.

In the illustrated embodiment of FIG. 7, the undulating pattern 260 includes a plurality of trapezoidal projections 262 forming the respective peaks 112. Each trapezoidal projection 262 from the plurality of trapezoidal projections 262 tapers inwardly in a direction D from the respective peak 112 towards the arcuate base 102. Such undulating pattern 260 may provide a “spring effect” to the shroud 250 that may help in returning the shroud 250 to original position after being subjected to any external forces.

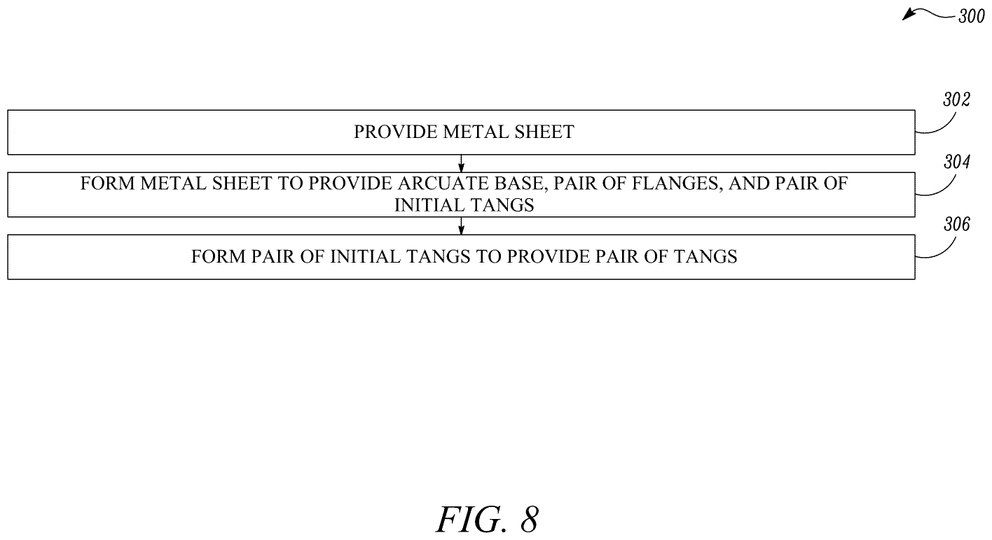

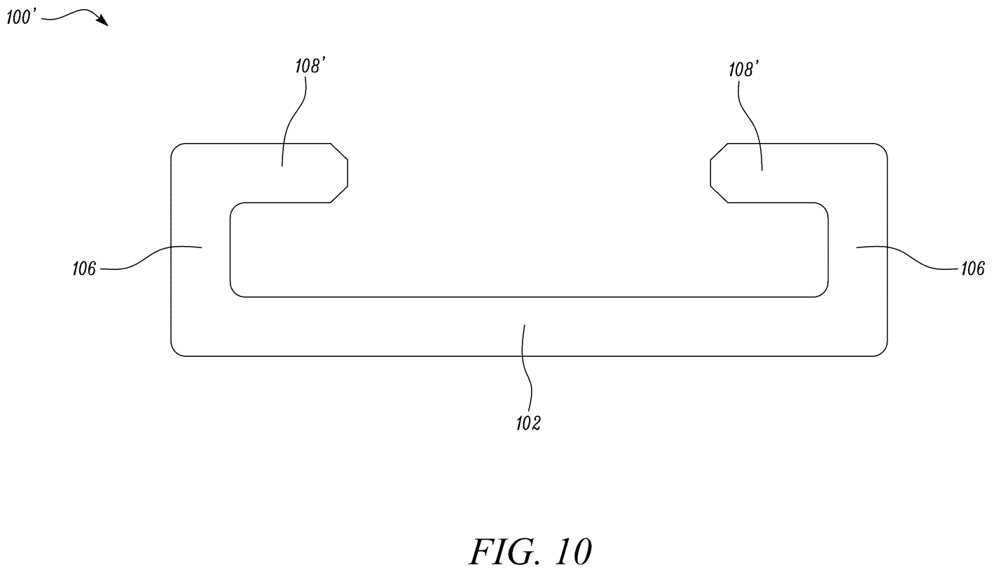

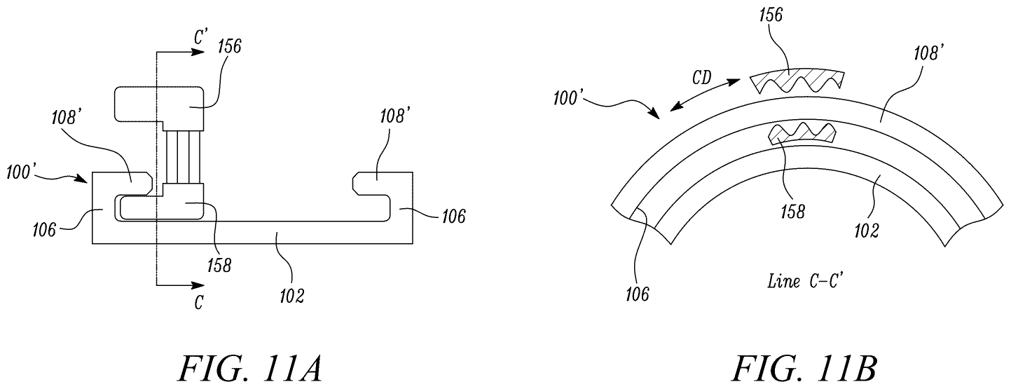

FIG. 8 is a flowchart for a method 300 of manufacturing the shroud 100 of FIG. 4, according to an embodiment of the present disclosure. The method 300 may also be used for manufacturing the shroud 200 of FIG. 6 and the shroud 250 of FIG. 7. FIG. 9 is an arrangement 140 for manufacturing an initial shroud 100′ (shown in FIG. 10) that is further used by the method 300 of FIG. 8 for manufacturing the shroud 100, according to an embodiment of the present disclosure. FIG. 10 is a sectional side view of the initial shroud 100′, according to an embodiment of the present disclosure. FIG. 11A is a sectional side view of the initial shroud 100′ of FIG. 10, the initial shroud 100′ being formed by a top tool 156 and a bottom tool 158, according to an embodiment of the present disclosure. FIG. 11B is sectional view of the initial shroud 100′ taken along a line C-C′ shown in FIG. 11A, the initial shroud 100′ being formed by the top tool 156 and the bottom tool 158, according to an embodiment of the present disclosure.

Referring to FIGS. 8 to 11B, at step 302, the method 300 includes providing a metal sheet 150 (shown in FIG. 9). At step 304, the method 300 includes forming, by a plurality of rollers 152 (shown in FIG. 9), the metal sheet 150 to provide the arcuate base 102, the pair of flanges 106, and a pair of initial tangs 108′ (shown in FIG. 10) extending from the pair of flanges 106. The initial tangs 108′ do not include any undulating pattern. In other words, at step 304, the method 300 includes manufacturing the initial shroud 100′ (shown in FIG. 10) by forming the metal sheet 150 shown in FIG. 9. Therefore, the arrangement 140 is used for manufacturing the initial shroud 100′ by forming the metal sheet 150. As shown in FIG. 10, the initial shroud 100′ includes the arcuate base 102, the pair of flanges 106, and the pair of initial tangs 108′ (without any undulating pattern) extending from the pair of flanges 106. The initial shroud 100′ is substantially similar to the shroud 100 of FIG. 4, with common components being referred to by the same numerals. However, the initial shroud 100′ includes the pair of initial tangs 108′ instead of the pair of tangs 108 of the shroud 100 as shown in FIG. 4.

At step 306, the method 300 includes forming the pair of initial tangs 108′ to provide the pair of tangs 108 including the undulating pattern 110 (shown in FIG. 5). As shown in FIGS. 11A and 11B, in some embodiments, forming the pair of initial tangs 108′ further includes incrementally forming the pair of initial tangs 108′ between the top tool 156 and the bottom tool 158 in a circumferential direction CD (shown in FIG. 11B). The top tool 156 and the bottom tool 158 together form the undulating pattern 110 shown in FIG. 5.

The top tool 156 and the bottom tool 158 may be, but not limited to, a die. The top tool 156 and the bottom tool 158 may be “indexed” to incrementally form the undulating pattern 110 shown in FIG. 5. This may ensure that forming the undulating pattern 110 of the pair of tangs 108 is cost effective and easy to implement.

In some embodiments, the pair of initial tangs 108′ is formed using one or more rollers 152 from the plurality of rollers 152 that form the metal sheet 150. In other words, the arrangement 140 including the one or more rollers 152 may be used for forming the pair of initial tangs 108′ in order to provide the tangs 108 including the undulating pattern 110 shown in FIG. 5. Therefore, the arrangement 140 may be used for forming the metal sheet 150 as well as forming the pair of initial tangs 108′ to provide the shroud 100 shown in FIGS. 4 and 5. In some embodiments, the one or more rollers 152 may be provided with a customized pattern to produce the undulating pattern 110 of the tangs 108.

Referring to FIGS. 1 to 11B, the method 300 involves the use of metal sheet 150 to manufacture the shroud 100 of the gas turbine engine 10. By using the arrangement 140 shown in FIG. 9, the metal sheet 150 may be bent to form the initial shroud 100′. Since the method 300 of manufacturing the shroud 100 includes using the metal sheet 150 and forming steps rather than conventional techniques involving forging and machining, a very small volume of high-quality material would be required to manufacture the shroud 100. Hence, unlike the conventional techniques of shroud manufacturing such as forging and machining, the method 300 may significantly reduce the scrap metal in the manufacturing process, and thereby, providing efficient material utilization and cost-effective manufacturability of the shroud 100. Forming of the metal sheet 150 may not be labour intensive and may not involve higher cost of materials.

The manufacturing of the shroud 100 is preferably carried out using the roll forming process. This may ensure easy manufacturing of shrouds 100 that could otherwise require a considerable height in conventional techniques to produce forged and machined components. Moreover, cold rolling of the metal sheet 150 may be used to increase or regulate the strength of the metal sheet 150 and thereby, controlling the material quality of the shroud 100. Additionally, an improved finished surface could be provided to the shroud 100 that does not require machining. Therefore, the method 300 may not involve complex machine tools and rough machining process for manufacturing the shroud 100. Moreover, the disclosed method 300 of manufacturing the shroud 100 may relatively use less energy, and therefore, may be more sustainable as compared to the conventional methods such as forging and machining.

Further, the method 300 manufactures the shroud 100 such that the shroud 100 may have the substantially uniform thickness which may optimize the durability and functionality of the shroud 100. The undulating pattern 110 of the pair of 108 tangs may ensure the tight interference fit between the shroud 100 and the plurality of stator vanes 60, thereby providing the firm support to the plurality of stator vanes 60 and the improved sealing property of the shroud 100.

It will be understood that the invention is not limited to the embodiments above described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A shroud for a gas turbine engine, the shroud comprising:
an arcuate base extending circumferentially about a central axis;
a pair of opposing flanges extending from respective axial ends of the arcuate base, each flange from the pair of flanges being inclined to the arcuate base; and
a pair of tangs spaced apart from the arcuate base and extending towards each other, each tang from the pair of tangs extending from a respective flange from the pair of flanges distal to the arcuate base, wherein each tang is inclined to the respective flange, each tang defining a width extending from the respective flange and a thickness orthogonal to the width;
wherein the arcuate base, the pair of flanges, and the pair of tangs define a slot therebetween configured to at least partially receive therein complementary mating features of a plurality of stator vanes of the gas turbine engine; and,
each tang comprises an undulating pattern extending along a whole of the thickness and at least a portion of the width, the undulating pattern comprising alternating peaks and valleys, such that the peaks are distal to the arcuate base and the valleys are proximal to the arcuate base, wherein the undulating pattern of each tang is configured to at least partially engage with the complementary mating features of the plurality of stator vanes.

2. The shroud of claim 1, wherein the undulating pattern is a sinusoidal pattern.

3. The shroud of claim 1, wherein the undulating pattern is a square wave pattern.

4. The shroud of claim 1, wherein the undulating pattern comprises a plurality of trapezoidal projections forming the respective peaks, and wherein each trapezoidal projection from the plurality of trapezoidal projections tapers inwardly in a direction from the respective peak towards the arcuate base.

5. The shroud of claim 1, wherein a height between each peak and the adjacent valley is greater than the thickness of the tang.

6. The shroud of claim 1, wherein each tang has a circumferential length, and wherein the undulating pattern extends along a whole of the circumferential length.

7. The shroud of claim 1, wherein the shroud is formed from a single metal sheet.

8. The shroud of claim 1, wherein each flange is orthogonal to the arcuate base.

9. The shroud of claim 1, wherein each tang is orthogonal to the flange and parallel to the arcuate base.

10. A shroud ring for a gas turbine engine, the shroud ring comprising a plurality of shrouds of any preceding claim contiguously connected to each other, such that the shroud ring extends circumferentially by 360 degrees about the central axis and forms a circumferential slot formed by the slots of the plurality of shrouds.

11. A gas turbine engine comprising the shroud ring of claim 10.

12. The gas turbine engine of claim 11, further comprising a plurality of stator vanes coupled to the shroud ring, each stator vane comprising a complementary mating feature that is at least partially received within the circumferential slot of the shroud ring.

13. A method of manufacturing the shroud of claim 1, the method comprising:
providing a metal sheet;
forming, by a plurality of rollers, the metal sheet to provide an arcuate base, a pair of flanges, and a pair of initial tangs extending from the pair of flanges; and
forming the pair of initial tangs to provide a pair of tangs comprising an undulating pattern.

14. The method of claim 13, wherein forming the pair of initial tangs further comprises incrementally forming the pair of initial tangs between a top tool and a bottom tool in a circumferential direction, the top tool and the bottom tool together forming the undulating pattern.

15. The method of claim 13, wherein the pair of initial tangs is formed using one or more rollers from the plurality of rollers that form the metal sheet.
